(19) United States
(12) Patent Application Publication
(10) Pub. No.: US 2008/0133669 A1
(43) Pub. Date: Jun. 5, 2008

(54) SENDING AND RECEIVING ELECTRONIC MAIL USING GROUP HEADERS

(76) Inventors: Li Ge, Austin, TX (US); Hui Jiang, Austin, TX (US); Yu Tang, Round Rock, TX (US); Ping Wang, Austin, TX (US)

Correspondence Address: IBM CORP (YA);C/O YEE & ASSOCIATES PC, P.O. BOX 802333, DALLAS, TX, 75380, US

(21) Appl. No.: 11/565,032

(22) Filed: Nov. 30, 2006

(51) Int. Cl. G06F 15/16

(52) U.S. Cl. 709/206

(57) ABSTRACT

A computer implemented method and apparatus for sending and receiving electronic mail messages. A group header is defined using simple mail transmission protocol. The group header provides information about a set of members of a group. The set of members of the group are one or more recipients of the electronic mail message. The group header is placed in the electronic mail message to form a completed electronic mail message addressed to the group. The completed electronic mail is sent to the group.

### BACKGROUND OF THE INVENTION

1. Field of the Invention

The present invention relates generally to data processing systems and in particular to electronic mail. Still more particularly, the present invention relates to a computer implemented method, apparatus, and computer program product for sending and receiving electronic mail using group headers.

2. Description of the Related Art

A company may use electronic mail (email) for communication within the company and between the company and outsiders, such as customers and suppliers. Typically, when someone sends emails to the same group of people on a regular basis, the sender defines a group of email recipients and sends an email to each member of the group simultaneously using the group as the email recipient. The group is private because the group exists only on the sender's email server. As a result, this group is not accessible to any members of the group.

Thus, when a group member receives an email addressed to the group, the group member cannot respond to the entire group because the group member does not have access to group information, such as the email address for each member of the group. The group member can respond only to the sender of the email and ask the sender to forward his or her response to the group. One solution to the problem of group email recipients not being able to see other recipients is to allow senders of email to publish the group list and make the identities of the group public. However, two drawbacks are present in this approach.

First, a member of the group who wants to send email to the rest of the group typically must use the same email server as other members of the group. Thus, any member of the group that is not on the same email server as the rest of the group cannot respond to emails addressed to the group. Second, it is not possible to confine the sharing of group information to members of the group, because once the group is published on the email server, anyone using the email server may see the group information.

### SUMMARY OF THE INVENTION

The different embodiments provide a computer implemented method and apparatus for sending and receiving electronic mail messages. A group header is defined using simple mail transmission protocol. The group header provides information about a set of members of a group. The set of members of the group are recipients of the electronic mail message. The group header is placed in the electronic mail message to form a completed electronic mail message addressed to the group. The completed electronic mail is sent to the group.

### BRIEF DESCRIPTION OF THE DRAWINGS

The novel features believed characteristic of the invention are set forth in the appended claims. The invention itself, however, as well as a preferred mode of use, and further objectives and advantages thereof, will best be understood by reference to the following detailed description of an illustrative embodiment when read in conjunction with the accompanying drawings, wherein:

FIG. 1 depicts a pictorial representation of a network of data processing systems in accordance with an illustrative embodiment;

FIG. 2 is a block diagram of a data processing system in which illustrative embodiments may be implemented;

FIG. 3 is a block diagram of components used to exchange emails in accordance with an illustrative embodiment;

FIG. 4 is a definition of a group header in accordance with an illustrative embodiment;

FIG. 5 is an example of email headers in accordance with an illustrative embodiment;

FIG. 6 is a flowchart of a process for an electronic mail sender in accordance with an illustrative embodiment; and

FIG. 7 is a flowchart of a process for an electronic mail recipient in accordance with an illustrative embodiment.

### DETAILED DESCRIPTION OF THE PREFERRED EMBODIMENT

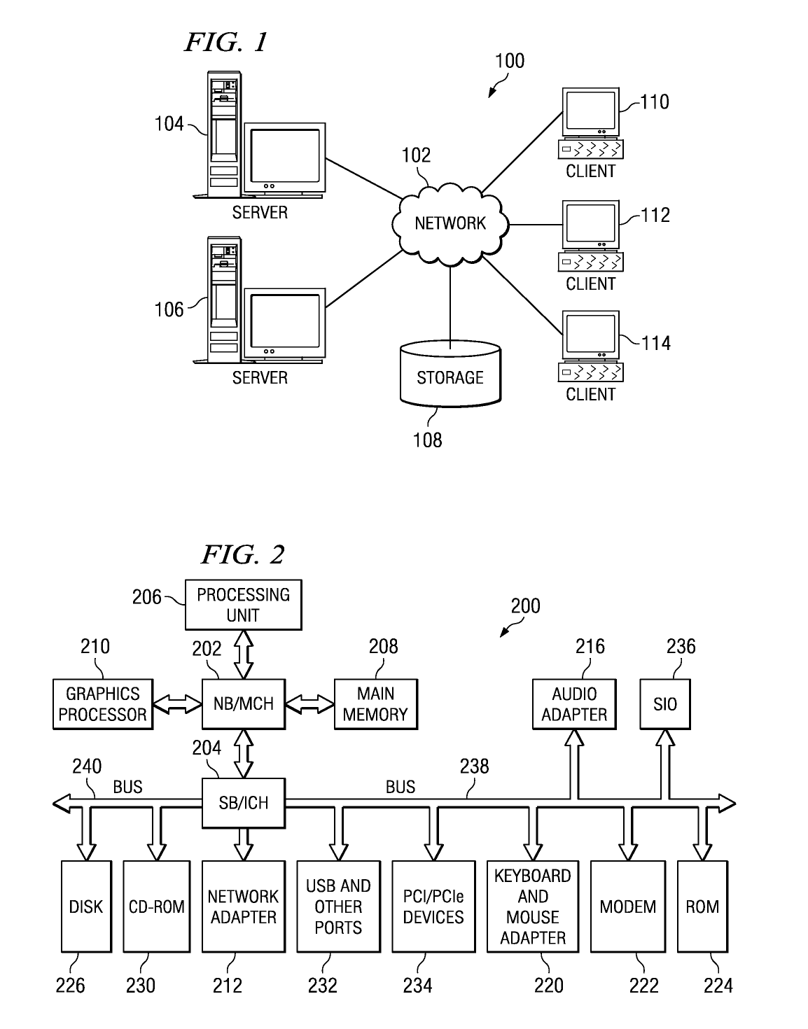

With reference now to the figures, and in particular with reference to FIGS. 1-2, exemplary diagrams of data processing environments are provided, in which illustrative embodiments may be implemented. It should be appreciated that FIGS. 1-2 are only exemplary, and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Email is commonly used for communication between employees in a company and between employees and outsiders, such as customers and suppliers. When someone regularly sends emails to the same set of people, the sender typically defines a group of email recipients, and sends an email to each member of the group. A set consists of one or more people. In this example, the set is one or more recipients for the email. The group definition exists only on the sender's email server, and is not accessible to any of the other members of the group.

When a member of the group receives an email addressed to the group, the member cannot respond to the entire group, because the group member does not have access to the email address for each member of the group. The group member can respond only to the sender of the email because that is the only email address available to the recipient.

Some email servers, such as Lotus Domino®, solve this problem by allowing senders of email to publish the group list and make the identities of the group public. However, this approach has two problems. First, a member of the group who wants to send email to the rest of the group typically must use the same email server as other members of the group. Second, it is not possible to confine the sharing of group information to members of the group because once the group is published on the email server, anyone using the email server may see the group information.

Therefore, the different illustrative embodiments provide a computer implemented method and apparatus for sending and receiving electronic mail messages. A group header is defined using simple mail transmission protocol. The group header provides information about a set of members of a group. The set of members of the group are one or more recipients of the electronic mail message. The group header is placed in the electronic mail message to form a completed electronic mail message addressed to the group. The completed electronic mail is sent to the group.

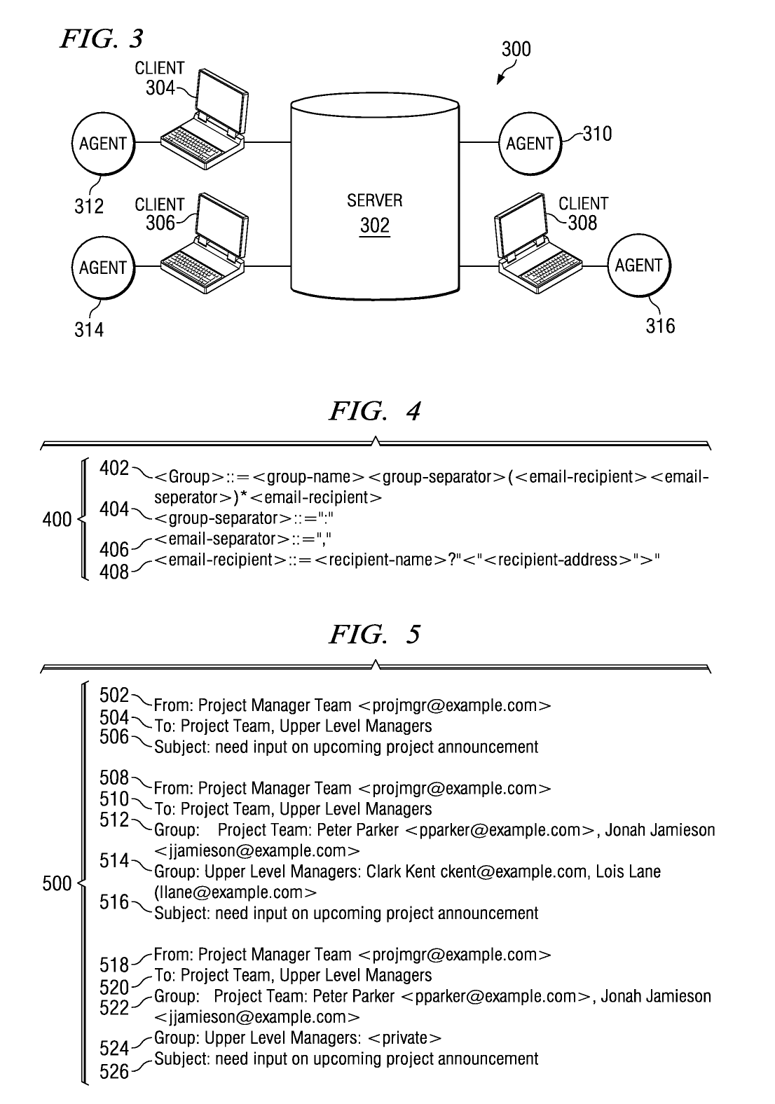

Referring to FIG. 3, a block diagram of a system of components used to exchange emails is shown in accordance with an illustrative embodiment. System 300 is used to exchange electronic mail. In system 300, server 302 is an email server. Server 302 may be a server such as server 104 and 106 in FIG. 1. Clients 304, 306, and 308 are clients, such as clients 110, 112, and 114 in FIG. 1.

A simple mail transfer protocol (SMTP) agent, which is a software process for sending and receiving emails, runs on each client's computer and on each server. In this example, simple mail transmission protocol agent 310 runs on server 302, and simple mail transmission protocol agents 312, 314, and 316 run on clients 304, 306, and 308, respectively.

Simple mail transmission protocol agents 310, 312, 314, and 316 use simple mail transmission protocol for exchanging emails. Embodiments extend the simple mail transmission protocol by introducing new simple mail transmission protocol headers for managing groups. Simple mail transmission protocol defines a set of standard email headers such as “To” and “From” to facilitate the exchange of information between simple mail transmission protocol agents. In the illustrative embodiments, these currently used email headers are augmented to use an additional type of header called “group”.

Referring to FIG. 4, reference numeral 400 depicts a definition of a group header in accordance with an illustrative embodiment. In definition of a group header 400, an example of how a group header may be defined is given using Backus-Naur form (BNF). Backus-Naur form is a notation for formally defining the grammar of a computer language so that no disagreement or ambiguity occurs as to what is permitted and what is not permitted in the computer language. The definition of a group header depicted in FIG. 4 is purely for the purpose of illustration. The group header may be defined in other ways, depending on the implementation.

Line 402 defines a group as having one or more group names separated by a group separator. Line 404 defines the group separator as a colon “:”. Line 402 also specifies that the group name is followed by a list of email recipients, with each recipient separated by an email separator. Line 406 defines the email separator as a comma “,”. Line 408 defines that each email recipient is specified by providing the recipient's name and the recipient's email address.

Referring to FIG. 5, reference numeral 500 depicts examples of email headers, in accordance with an illustrative embodiment. In email headers 500, lines 502-506 depict an example of the simple mail transmission protocol headers in a conventional system, where a group header is not defined. The email is addressed to the recipients listed in line 504, the groups Project Team and Upper Level Managers. As previously discussed, in a conventional system, the recipients of this email do not know the email addresses of the members of each group. Therefore, the recipients cannot send an email response to the groups Project Team and Upper Level Managers.

In email headers 500, lines 508-516 depict an example of simple mail transmission protocol headers in a system where a group header has been defined. Line 510 is the same as line 504, and shows the name of one or more groups to which the email is addressed. Thus, one advantage of defining group headers is that an email can be sent to more than one group.

Lines 512 and 514 show recipient information for the two groups mentioned in line 510. Specifically, line 512 displays information, such as the name and email address, for the members of the group named Project Team. Similarly, line 514 displays information for the members of the group named Upper Level Managers.

One advantage of implementing groups in the manner described above is that this method is backwards compatible. For example, the above approach will work in a mixed network in which some simple mail transmission protocol email agents recognize the group definition and others do not. If a recipient's simple mail transmission protocol email agent does not recognize the group header, then the recipient's simple mail transmission protocol email agent can simply ignore the group header, and operate as it would in a conventional system.

Once the group headers are defined in simple mail transmission protocol, the sender's simple mail transmission protocol email agent maintains the group definition locally. When an email is sent to the group, the simple mail transmission protocol email agent, such as agent 312 in FIG. 3, adds the group fields to the email. Specifically, the simple mail transmission protocol email agent adds the name of each group which the email is addressed to as shown in line 510.

If the recipient's simple mail transmission protocol email agent recognizes the group header, then when the recipient replies to the email, the simple mail transmission protocol email agent extracts the group header information and builds the appropriate headers. For example, line 512 shows information about the members of the Project Team group, and line 514 shows information about the members of the Upper Level Managers group.

Typically, the information about each member of the group is the intended recipient's name and email address. Of course, those versed in the art will appreciate that additional or different information about each recipient may also be listed.

Those versed in the art will appreciate that the recipient's simple mail transmission protocol email agent may provide other features using the group header. For example, the recipient may be allowed to import the group information to the recipient's local address book.

Optionally, when a sender defines multiple groups of recipients, the sender may choose to designate a group as public or private. A public group is one in which the recipient can see information about the group, such as the names and email addresses of the recipients. The recipient may also be allowed to import the public group and the group's members to a local server. A private group is a group, which does not allow the recipient to see the group members' information.

For example, lines 518-526 are an example of email headers in which the group Project Team is public but the group Upper Level Managers is private. Therefore, because the group Project Team is public, information about the group is displayed on line 522. Because the group Upper Level Managers is private in this example, group information is not displayed, and instead the group information is indicated as private in line 524. Thus, if a group is designated as private, group information is not sent by the sender's simple mail transmission protocol email agent.

Optionally, when a sender defines multiple groups, the sender may designate which recipients have access to group information. Thus, one recipient may see the group information for both groups, a second recipient may see the group information for one group but not another, and a third recipient may not see group information for either group. In this scenario, a recipient will only see group information if (i) the recipient has designated the group as a public group, and (ii) the recipient has designated the recipient as someone who can view the members of the group.

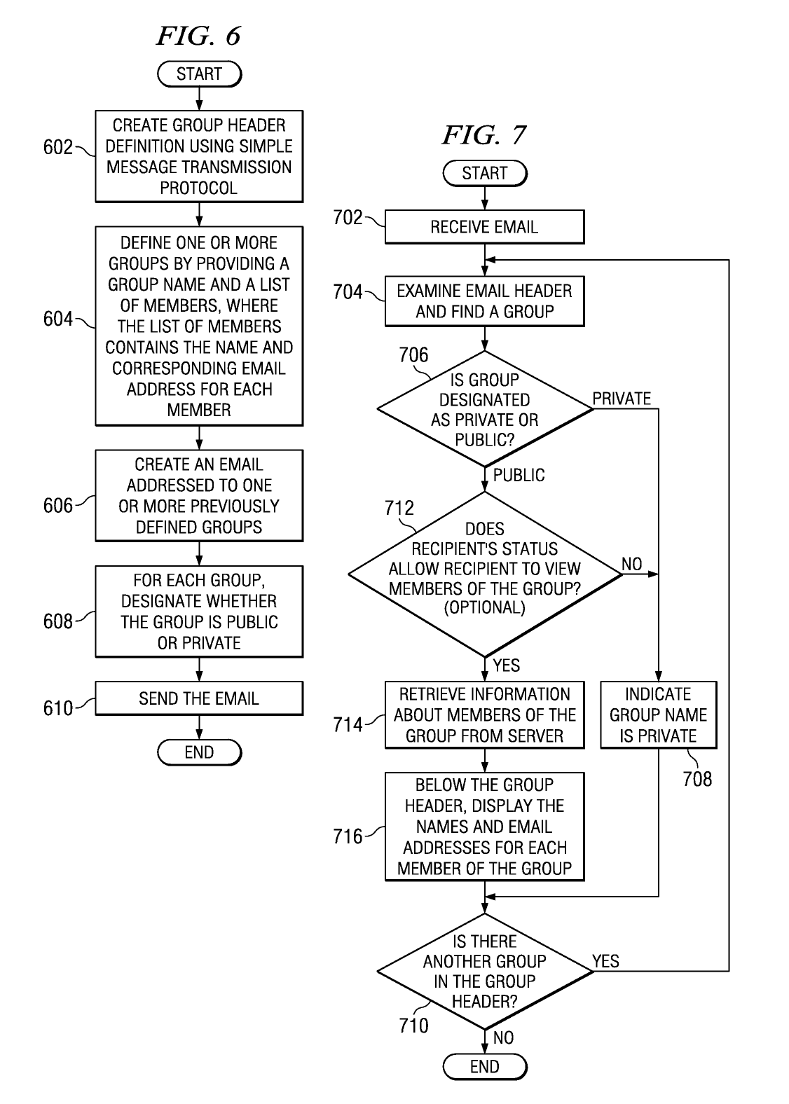

FIG. 6 is a flowchart of a process for an electronic mail sender in accordance with an illustrative embodiment. Electronic email software, such as agent 312 in FIG. 3, allows a user access to an electronic mail server, such as server 302 in FIG. 3. In the illustrative example shown in FIG. 6, the process is implemented by electronic mail software.

The process begins when a user uses the electronic mail software to create a group header definition using simple message transmission protocol (step 602). For example, a systems administrator may create the group header definition on an email server, such as server 302, using an agent, such as agent 310 in FIG. 3.

The user uses the software to define one or more groups (step 604). Each group has a group name and a list of group members. The list of group members contains a name and electronic mail address for each member of the group. A group may be defined by a system administrator or by any user with access to electronic mail.

The user uses the software to create an electronic mail addressed to one or more previously defined groups (step 606). The user may use electronic mail software, such as agent 312, to create the electronic mail. The electronic mail may be sent using an electronic mail server, such as server 302 in FIG. 3.

For each group, the user uses the software to designate whether the group is public or private (step 608). If a user designates that a group is public, then the recipients of the electronic mail may view the members of the group as shown in line 522 of FIG. 5. If a user designates that a group is private, then the recipients of the electronic mail may not view the members of the group as shown in line 524 of FIG. 5. The user then uses the software to send the email (step 610) and the process ends.

FIG. 7 is a flowchart of a process for an electronic mail recipient in accordance with an illustrative embodiment. For example, in FIG. 3, suppose client 304 sends an electronic mail to client 306 using server 302. When client 308 receives the electronic mail, the electronic mail is processed by agent 310, agent 316, or a combination of agent 310 and agent 316 in FIG. 3. In the illustrative example shown in FIG. 7, the process is implemented by a software process for sending and receiving emails, such as agent 312 in FIG. 3.

The process begins once an electronic mail message is received (step 702). The agent examines a header of the email and finds a group name (step 704). The agent makes a determination as to whether the sender of the electronic mail designated the group as a private group or a public group (step 706).

If the group is designated private, the agent indicates that the recipient of the electronic mail is private (step 708). For example, the electronic mail may display a blank field after the word “Group”, or the electronic mail may display the word “private” after the word “Group” to indicate that the group is private. A determination is made as to whether another group is present in the group header (step 710). If the answer is “no” and no more group headers are present, then the process ends. If the answer is “yes” and another group is present, then the group name is extracted from the group header (step 704) and the process repeats.

If the group is designated as public, then optionally, a determination is made as to whether the status of the recipient allows the recipient to view the members of the group (step 712). If the status of the recipient does not allow the recipient to view the members of the group, then the process indicates that the group name is private (step 708).

If the status of the recipient allows the recipient of the electronic mail to view the members of the group, or if the determination in step 712 is optionally not performed, then the information about the members of the group is retrieved (step 714) from a mail server, such as server 302 in FIG. 3. Generally, the group information is retrieved from the server used by the sender of the electronic mail because that is where the sender defined the group. However, the recipient may have previously received an electronic mail containing the same group, and the recipient may have imported the group to the recipient's server. If the recipient had previously imported the group, then the group information may be retrieved from the recipient's server instead of the sender's server.

Once the electronic mail agent of the recipient retrieves the group information from the server, the electronic mail agent displays the names and electronic mail addresses for each member of the group (step 716). Next a determination is made as to whether another group is present in the group header (step 710). If the answer is “no” and no more group headers are present, then the process ends. If the answer is “yes” and another group is present, then the group name is extracted from the group header (step 704) and the process repeats.

Therefore, the different illustrative embodiments provide a computer implemented method and apparatus for sending and receiving electronic mail messages. A group header is defined using simple mail transmission protocol. The group header provides information about a set of members of a group. The set of members of the group are one or more recipients of the electronic mail message. The group header is placed in the electronic mail message to form a completed electronic mail message addressed to the group. The completed electronic mail is sent to the group.

The different embodiments allow a group of email recipients to be defined so that emails may be addressed to the group instead of addressing the email to individual recipients. In one embodiment, the group may be designated as public or private. If a group is public then each recipient can see the other members of the group and may import the group to a local email server so that the recipient can send emails to the group. If a group is private then each recipient may not see other members of the group and may not import the group and the members of the group to a local email server.

In another embodiment, each recipient is given a status which determines whether or not the recipient can view the other members of the group. In this embodiment, a group must be public and the recipient must be designated as someone who can view members of the group in order for the recipient to view the other members of the group.

For example, suppose an email is composed and sent to one department, and the department has several teams, with each team led by a team leader. Suppose a public group is created for all members of the department, and only the team leaders are designated as recipients who can view members of the group, while the rest of the department members are designated as not being able to view members of the group. In this example, each team leader in the department can view members of the group and send emails to the entire group. However, the other members of the department who are not team leaders may not view other members of the group and may not send emails to the group.

The flowchart and block diagrams in the figures illustrate the architecture, functionality, and operation of some possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for sending and receiving electronic mail messages, the computer implemented method comprising:
defining a group header in simple mail transmission protocol, wherein the group header provides information about a set of members of a group, and wherein the set of members of the group are recipients of the electronic mail message;
placing the group header in the electronic mail message, wherein the electronic mail message is addressed to the group to form a completed electronic mail message; and
sending the completed electronic mail message to the group.

2. The computer implemented method of claim 1, wherein sending the completed electronic mail message to the group comprises:
placing a group field in the electronic mail message, wherein the group field indicates that the electronic mail message is addressed to the group.

3. The computer implemented method of claim 1, further comprising:
receiving the completed electronic mail message by a member of the group;
determining whether the member of the group can extract group information; and
responsive to a determination that the member of the group can extract group information, extracting group information from the group header of the electronic mail message.

4. The computer implemented method of claim 3, wherein the group is designated public, and wherein extracting group information from the group header results in a list of one or more members of the group, wherein each member of the group is specified using a user name and an electronic mail address.

5. The computer implemented method of claim 3, wherein the group is designated private, and wherein the member of the group receiving the electronic mail message cannot extract group information from the group header.

6. The computer implemented method of claim 3, further comprising:
assigning each member of the group a status;
responsive to a determination that the status of the member of the group permits the member to extract group information from the group header, extracting group information from the group header of the electronic mail message; and
responsive to a determination that the status of the member of the group does not permit the member to extract group information from the group header, not extracting group information from the group header of the electronic mail message.

7. A data processing system for sending and receiving electronic mail messages, the data processing system comprising:
a bus;
a storage device connected to the bus, wherein the storage device contains computer usable code;
a communications unit connected to the bus;
a processing unit connected to the bus, wherein the processing unit executes the computer usable code to define a group header in simple mail transmission protocol, wherein the group header provides information about a set of members of a group, and wherein the set of members of the group are recipients of the electronic mail message; places the group header in the electronic mail message, wherein the electronic mail message is addressed to the group to form a completed electronic mail message; and sends the completed electronic mail message to the group.

8. The data processing system of claim 7 wherein the processor unit further executes the computer usable program code to place a group field in the electronic mail message, indicating that the electronic mail message is addressed to the group.

9. The data processing system of claim 8, further comprising:
a member of the group, wherein the member of the group receives the electronic mail message; and wherein the processor unit further executes the computer usable program code to determine whether the member of the group can extract group information and, responsive to a determination that the member of the group can extract group information, extracts the group information from the group header of the electronic mail message.

10. The data processing system of claim 9, wherein the group is designated public, and wherein the processor unit further executes the computer usable program code to extract the group information from the group header as a list of one or more members of the group, and wherein each member of the group is specified using a user name and an electronic mail address.

11. The data processing system of claim 9, wherein the group is designated private, and wherein the member of the group receiving the electronic mail cannot extract group information from the group header.

12. The data processing system of claim 9, wherein each member of the group is assigned a status, and wherein the processor unit further executes the computer usable program code to make a determination as to the status of the member of the group, responsive to a determination that the status of the member of the group permits the member to extract group information from the group header, the processor unit extracts group information from the group header of the electronic mail message, and responsive to a determination that the status of the member of the group does not permit the member to extract group information from the group header, the processor unit does not extract group information from the group header of the electronic mail message.
